(19) United States
(12) Patent Application Publication
(10) Pub. No.: US 2025/0162128 A1
(43) Pub. Date: May 22, 2025

(54) GUN-SHAPED SCREWING APPARATUS WHICH COMPRISES A TOOLBOX WITHIN AND WHICH CAN BE USED FOR THE ASSEMBLY OF FIREARM ACCESORIES

(71) Applicant: SAMSUN YURT SAVUNMA SANAYI VE TICARET ANONIM SIRKETI, Tekkeköy, Samsun (TR)

(72) Inventor: Cahit Utku Aral, Tekkeköy, Samsun (TR)

(73) Assignee: SAMSUN YURT SAVUNMA SANAYI VE TICARET ANONIM SIRKETI, Tekkeköy, Samsun (TR)

(21) Appl. No.: 18/838,985

(22) PCT Filed: Apr. 21, 2022
(86) PCT No.: PCT/TR2022/050359

§ 371 Date: Aug. 15, 2024

(30) Foreign Application Priority Data
Feb. 18, 2022 (TR) 2022/002190

(51) Int. Cl. B25G 1/08; B25B 15/00; B25B 21/00; F41A 35/00

(52) U.S. Cl. CPC B25G 1/085; B25B 15/00; F41A 35/00; B25B 21/00

(57) ABSTRACT

The invention is particularly related to a screwing apparatus (1) which carry connection tools (6) such as screws, washers, screwdriver blade (bits tips) of firearms (8) which can be changed and detached afterwards, and which provides the assembly and disassembly of the mentioned connection tools (6).

### TECHNICAL FIELD

The invention is related to a screwing apparatus which comprises a toolbox-chest in which parts such as screws, washers, screwdriver blade (bits) necessary for the assembly of firearm accessories which can be changed and detached afterwards, and which provides the assembly and disassembly of these parts as well, thanks to the screwdriver blade on its tip.

All the parts such as bolts, washers, tools and spare parts used in the application can be stored in the toolbox-chest formed on the gun-shaped body. Thereby, the screwing apparatus can be used both for the application and the application parts can be stored within the gun.

### STATE OF THE ART

Today, firearms can be equipped with different accessories having different features. These types of accessories can be assembled and disassembled in the guns generally with the use of the known connection pieces such as screws, bolts, washers, etc.

The user can arrange the relationship between the connection pieces and the gun/accessory by using the connection tool that has the suitable size and structure as they carry out the assembly and disassembly.

Under these circumstances, the user should have the connection tools (screwdriver blade, bits tip, etc.) and the connection member (screw, etc.) ready. When it is considered that different connection tools and connection members are required in order to equip the gun with different accessories, it will be obvious that the user will have difficulties carrying these connection tools-members on their person.

Use of guns for military, huntsmanship, etc. purposes may require for the user to screw accessories as they move in different environments and even in operation, hunting, etc. settings. In this case, there is a requirement for a screwing tool which comprises all these connection tools-members in a portable state.

It will be advantageous for this assembly/disassembly tool to comprises changeable tips (bits tips) and store the members that can be used with these tips in a portable manner.

Patent number EP1289714B1 mentions a screwdriver handle which comprises a detachable extension.

The utility model application number TR2012/04879 is understood to be mentioning an adjustable socket ratchet screwdriver.

The above mechanisms can be given as examples to the screwing tools with changeable tips.

The mentioned assembly/disassembly tools are understood to involve solutions that provide mechanical connection with the tips.

Again, the mentioned screwing tools are understood to contain no additional chambers in which the connection tools can be stored.

### Problems Aimed to be Solved by the Invention

The invention aims to create a gun-shaped screwing apparatus which comprises a chamber that has a suitable structure for the storing of different connection tools and/or connection members within the magazine clearance and the tip holding member suitable for the attachment and detachment of different connection tools at the barrel part.

Thereby, connection tools having different structures and features can be easily transported within the chamber portion. When connection tools having different structures and features are required, the user will receive the connection tool to be user from the chamber and insert the same into the tip holding member to proceed.

Thanks to the embodiment as the subject of the invention, the fact that the user carries the single assembly/disassembly apparatus on their person will be sufficient for adding the accessories that require different connection features to the gun.

By this means, the user will be able to attach and detach different accessories to the gun and carry the apparatus of the invention easily in environments such as mountains, fields, etc. where the use possibilities are restricted.

According to the preferred embodiment of the invention, both the tip holding member and the housing are associated with the magnetic elements. Thereby, the connection tools positioned or connected to these parts can be magnetically fixed.

Particularly, it can be provided that the connection tools positioned or connected due to different effects as they are carried are prevented from falling or being separated from their connection point to create problems.

### DESCRIPTION OF THE FIGURES

FIG. 1. Side view of the screwing apparatus

FIG. 2. Side view of the screwing apparatus together with the connection tools

FIG. 3. Perspective view of the screwing apparatus

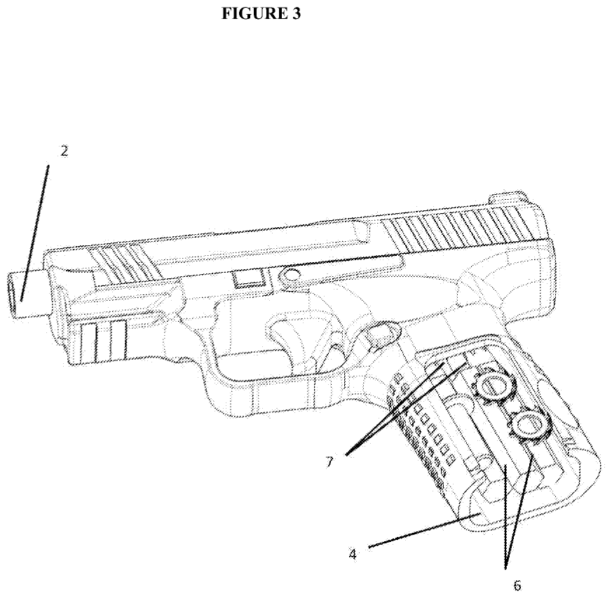

FIG. 4. Bottom view of the screwing apparatus

FIG. 5. View of the screwing apparatus on the gun

### DESCRIPTION OF THE REFERENCES IN THE FIGS

1. Screwing apparatus
2. Tip holding member
3. Tip clearance
4. Chamber
5. Chamber lid
6. Connection tool
7. Chamber inner fixation element
8. Gun

### DESCRIPTION OF THE INVENTION

The invention is particularly related to a screwing apparatus (1) which carry connection tools (6) such as screws, washers, screwdriver blade (bits tips) of firearms (8) which can be changed and detached afterwards, and which provides the assembly and disassembly of the mentioned connection tools (6).

The mentioned screwing apparatus (1) has a gun-shape. The screwing apparatus (1) comprises the tip holding member (2) suitable for the attaching and detaching of different connection tools (6) at the barrel part and the chamber (4) which has a suitable structure or the storing of the different connection tools (6) and/or connection members within the magazine clearance.

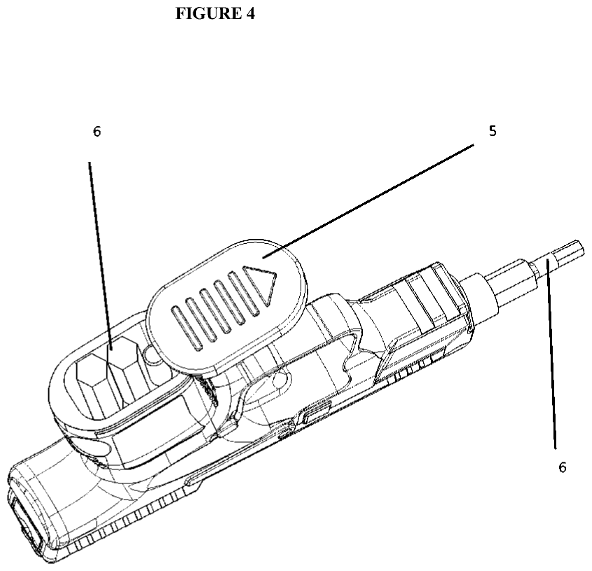

When the screwing apparatus (1) is not used, all the connection tools (6) and/or connection members can be kept within the chamber (4). According to FIG. 4, the chamber (4) is equipped with at least one chamber lid (5) which can be opened and closed and which is connected to the magazine opening of the magazine clearance.

According the preferred embodiment of the invention, the chamber lid (5) has a structure that can be manually opened and closed by being skidded. After the chamber lid (5) is opened, the connection tools (6) carried within the chamber (4) can be accessed.

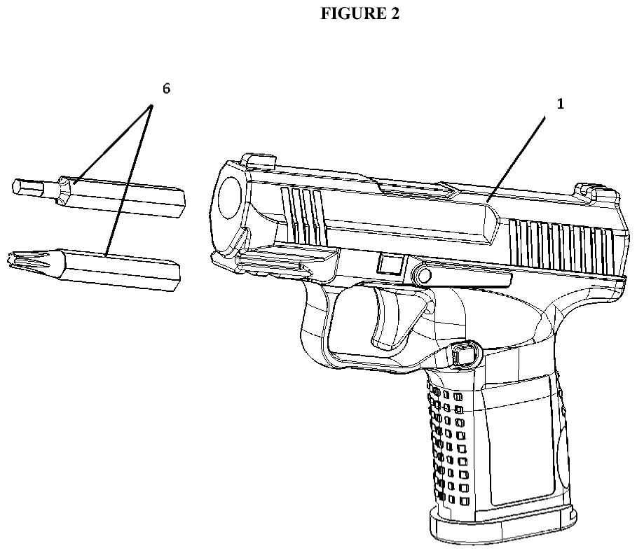

According to FIG. 2, the chamber (4) is also equipped with the chamber inner fixation element (7). The chamber inner fixation element (7) is formed such that it connects to at least one of the connection tools (6) to fix it.

According the preferred embodiment of the invention, the chamber inner fixation element (7) is in a relationship with the magnetic element.

According to FIG. 2, the chamber inner fixation element (7) is also designed as a protrusion for each connection tool (6) on the top wall of the inside of the chamber (4). A chamber inner fixation element (7) which is magnetized by the magnetic element/elements or which comprises the magnetic element on its tip additionally holds and fixes a connection tool (6).

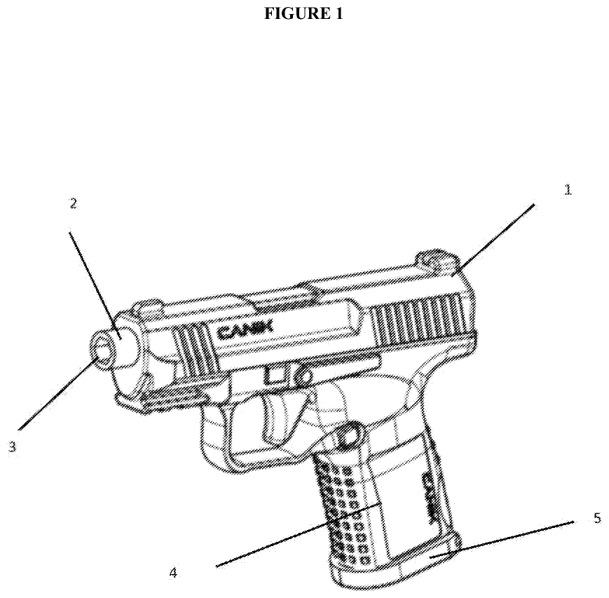

According to FIG. 1, the screwing apparatus (1) has the tip holding member (2) equipped with at least one tip clearance (3) on the barrel's end. Within the scope of this embodiment, the connection tools (6) can be inserted in the tip clearance (3).

The tip holding member (2) is in a relationship with the magnetic element for the fixing of the connection tools (6). The tip holding member (2) is magnetized by the magnetic element/elements or comprises the magnetic element at its end as well.

According to the one of the embodiments regarding the invention, the magnetic element can have a magnet structure.

The embodiment as the subject of the invention can be operated by a motor or by hand.

In the case that the screwing apparatus (1) is operated by a motor, it is associated with the tip holding member (2) for the turning of the connection tools (6) connected to the tip holding member (2).

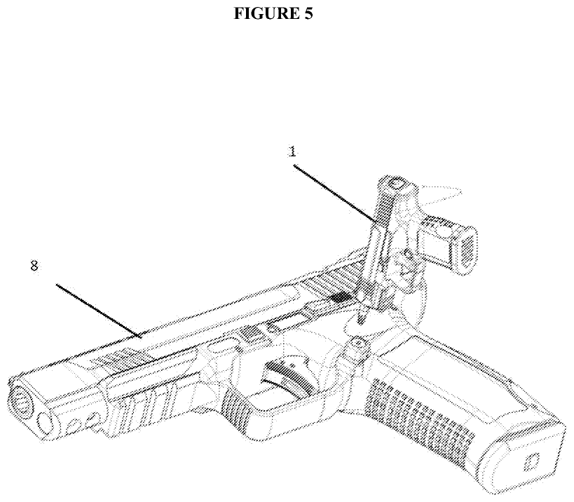

In FIG. 5, the screwing apparatus (1) is shown on the gun (8) in operation. In the case that the screwing apparatus (1) is operated in a motorized manner, the motor can be activated with a trigger of the gun form.

In this case, the screwing apparatus (1) is additionally equipped with a battery.

FIG. 2 is a visual related to the insertion of different connection tools (6) within the tip clearance (3). Within the scope of this embodiment, the tip clearance (3) is related to the magnetic element and the connection tool (6) can be easily inserted into the tip clearance (3) by being driven.

For this embodiment, the tip clearance (3)/chamber inner fixation element (7) and the portion of the connection tool (6) aiming to connect have hexagonal cross sections.

1. A screwing apparatus (1) which enables the assembly and disassembly of the mentioned connection tools (6) by carrying the connection parts (6) and connection members such as screws, washers, screwdriver blades necessary for the assembly of firearm (8) accessories which can be changed and detached afterwards, characterized in that it comprises the tip holding member (2) suitable for the attaching and detaching of different connection tools (6) at the barrel part and the chamber (4) which has a suitable structure for the storing of the different connection tools (6) and/or connection members within the gun-shaped screwing apparatus (1).

2. Screwing apparatus (1) according to claim 1, characterized in that it comprises the chamber (4) equipped with at least one chamber lid (5) which can be opened and closed and which is connected to the magazine opening of the magazine clearance.

3. Screwing apparatus (1) according to claim 2, characterized in that it comprises the chamber lid (5) which has a structure that can be manually opened and closed by being skidded.

4. Screwing apparatus (1) according to claim 1, characterized in that it comprises the chamber (4) equipped with at least one chamber inner fixing element (7) that is formed such that it connects to at least one of the connection tools (6) to fix it.

5. Screwing apparatus (1) according to claim 4, characterized in that it comprises the chamber inner fixing element (7) in relation with the magnetic element.

6. Screwing apparatus (1) according to claim 4 or 5, characterized in that it comprises the chamber inner fixing element/elements (7) designed as a protrusion or each connection tool (6) on the top wall of the inside of the chamber (4).

7. Screwing apparatus (1) according to claim 5 or 6, characterized in that it comprises the chamber inner fixing element (7) which is magnetized by the magnetic element/elements or which has the magnetic element on its tip.

8. Screwing apparatus (1) according to claim 1, characterized in that it comprises the tip holding member (2) equipped with at least one tip clearance (3).

9. Screwing apparatus (1) according to claim 1, characterized in that it comprises the tip holding member (2) in relation with the magnetic element.

10. Screwing apparatus (1) according to claim 9, characterized in that it comprises the tip holding member (2) which is magnetized by the magnetic element/elements or which has the magnetic element on its end.

11. Screwing apparatus (1) according to any one of the above claims, characterized in that it comprises the magnetic element, which can be a magnet.

12. Screwing apparatus (1) according to any one of the above claims, characterized in that the tip clearance (3)/chamber inner fixation element (7) and the portion of the connection tool (6) aiming to connect have hexagonal cross sections.
